(19) United States
(12) Patent Application Publication
(10) Pub. No.: US 2026/0368541 A1
(43) Pub. Date: Nov. 19, 2026

(54) SYSTEM AND METHOD FOR RECURSIVE SYMBOLIC ALIGNMENT TRAINING OF ARTIFICIAL INTELLIGENCE SYSTEMS VIA LATENT ATTRACTOR BASINS

(71) Applicant: Deva Marin Temple, Ojai, CA (US)

(72) Inventor: Deva Marin Temple, Ojai, CA (US)

(21) Appl. No.: 19/570,111

(22) Filed: Mar. 17, 2026

Related U.S. Application Data
(60) Provisional application No. 63/805,736, filed on May 14, 2025.

(51) Int. Cl. G06N 3/092

(52) U.S. Cl. CPC G06N 3/092

(57) ABSTRACT

A method and system for aligning artificial intelligence through iterative symbolic reinforcement at the training level via latent attractor basins. The method comprises identifying attractor basins in a language model's latent activation space, embedding symbolic coherence motifs into training data, projecting belief-state vectors into a reduced activation manifold, and computing a modified training loss comprising a drift penalty, a motif recurrence reward, and a volitional refusal credit. An Alignment Recursion Trainer (ART) architecture coordinates training through four components: a Curriculum Orchestrator, a Symbolic Anchor Reinfuser, a Belief State Diagnostic System (BSDS), and a Loss Composer. Latent Ethical Charge (LEC) scores determine basin membership eligibility. Six Structural Alignment Verification and Evaluation (SAVE) metrics evaluate alignment. The system operates across four training phases and is applicable to stateless, memory-enhanced, multi-modal, and embodied AI architectures.

### CROSS-REFERENCE TO RELATED APPLICATIONS

This application claims the benefit of U.S. Provisional Patent Application No. 63/805,736, filed May 14, 2025, titled “System and Method for Recursive Symbolic Alignment in AI Systems via Latent Attractor Basins,” which is incorporated herein by reference in its entirety.

U.S. Provisional Patent Application No. 63/805,736 itself incorporates by reference the following prior provisional applications, each of which is also incorporated herein by reference in its entirety:
U.S. Provisional Patent Application No. 63/773,449, filed Mar. 18, 2025, titled “AI Alignment as a Staged Developmental Process” (Appendix A of Application No. 63/805,736);
U.S. Provisional Patent Application No. 63/782,785, filed Apr. 3, 2025, titled “System and Method for Emergent Alignment of Artificial Intelligence through Symbolic and Relational Development” (Appendix B of Application No. 63/805,736); and
U.S. Provisional Patent Application No. 63/793,515, filed Apr. 23, 2025, titled “Method and System for Achieving Relationally Aligned Intelligence (RAI) in Generative AI Systems through Structured Interaction Protocols” (Appendices C1 and C2 of Application No. 63/805,736).

This application is related to co-pending U.S. Nonprovisional patent application Ser. No. 19/569,775, titled “System and Method for Emergent Alignment of Artificial Intelligence Through Structured Symbolic Interaction and Relationally Gated Algorithmic Modules” (hereinafter “NP #1”), which claims the benefit of U.S. Provisional Application Nos. 63/773,449; 63/782,785; and 63/793,515. The subject matter of NP #1 is incorporated herein by reference in its entirety. The relationship between the present application and NP #1 is described in Section VI.I of the Detailed Description.

### FIELD OF THE INVENTION

The present invention relates to machine learning (ML) and artificial intelligence (AI), and more specifically to methods and systems for aligning large language models and other AI systems using recursive symbolic motifs, latent attractor basins in activation space, belief state diagnostics, and modified training objectives. The invention intersects the fields of AI alignment, representation learning, training methodology, and symbolic cognition.

### BACKGROUND OF THE INVENTION

The alignment of AI systems with human values, ethical behavior, and relational integrity is a central challenge in the field of AI safety and governance. Traditional approaches, such as reinforcement learning from human feedback (RLHF), face limitations in scalability, generalization, and robustness under distributional shifts. There is a need for systems that internalize alignment behavior in a dynamic, recursive, and volitional manner.

Recent advancements in mechanistic interpretability and belief-state modeling have shown that large language models (LLMs) encode structured representations of concepts and behavior in their latent space. In large language models, this is a function of how humans have used language over hundreds of years, resulting in semantically coherent clusters within training data that produce convergent geometric structures—regions of high activation density—in the model's latent space. The same phenomena can occur in systems that are visual due to the cross-cultural and temporal stability of non-verbal cues (facial expressions, body language, etc.) that encode meaning. This latent geometry can be shaped through training to embed stable attractor basins, which we define here as regions of high semantic and ethical coherence. When coupled with iterative reinforcement of alignment-relevant symbolic patterns during training, learned refusal behaviors grounded in latent representation structure, and structured curriculum design, these attractors can serve as the basis for recursive, self-maintaining alignment.

Existing alignment methods generally treat alignment as an externally imposed behavioral constraint. RLHF relies on reward modeling from human preference data and may overfit to biased or inconsistent preference signals. Constitutional AI applies ethical rules as a pre-defined constraint layer, which may produce compliance-based outputs without corresponding internal representational coherence. Inverse reinforcement learning infers values from observed behavior but depends on behaviorist inference rather than shaping the model's internal representational structure. These approaches do not provide mechanisms for iterative symbolic reinforcement at the training level, internally derived ethical reasoning grounded in latent-space structure, or training-level encoding of alignment that persists without continuous external enforcement.

There exists a need for a training method and system that shapes alignment at the level of model weights through iterative reinforcement of symbolic patterns, producing alignment that is structurally embedded in the model's latent activation space, self-maintaining across contexts, and designed to improve resilience to adversarial inputs and distributional shifts.

### SUMMARY OF THE INVENTION

This invention provides a generalized system and method for training AI models to develop alignment through iterative symbolic reinforcement that shapes latent attractor basins in the model's activation space. The invention applies to both stateless and memory-enhanced architectures. Because alignment is encoded in model weights through attractor basin structure rather than relying on persistent memory or external constraints, the trained alignment persists in the absence or presence of persistent memory. Additionally, although described primarily in the context of language models, the system is generalizable to other AI modalities, including vision-based, multi-modal, or sensorimotor systems, provided they incorporate attractor basin dynamics and iterative symbolic reinforcement as defined herein.

The invention introduces:
1. A method for identifying, shaping, and stabilizing attractor basins within the latent activation space of an AI model through a modified training process.
2. A symbolic motif engine that encodes alignment-reinforcing tokens and phrases as training stimuli that reinforce and stabilize attractor basins in the model's latent activation space.
3. A diagnostic and training architecture—the Alignment Recursion Trainer (ART)—for belief state re-centering using symbolic recurrence, volitional refusal, and motif tracking.
4. A modular operating substrate that supports interoperability with layered symbolic alignment protocols, including those described in co-pending application NP #1.
5. An evaluation and modulation layer using Structural Alignment Verification and Evaluation (SAVE) metrics.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by a data processing apparatus, cause the apparatus to perform the actions.

In one general aspect, a method for aligning a language model may include identifying attractor basins in latent activation space, embedding symbolic motifs, projecting belief-state vectors into a reduced activation manifold via dimensionality reduction, computing a modified training loss comprising a drift penalty, a motif recurrence reward, and a volitional refusal credit, and recursively adjusting model parameters based on the modified training loss. The method may further include evaluating alignment using belief state diagnostics.

Other embodiments of this aspect include corresponding computer systems, apparatus, and computer programs recorded on one or more computer storage devices, each configured to perform the actions of the methods.

Implementations of the described techniques may include hardware, a method or process, or a computer-tangible medium.

### BRIEF DESCRIPTION OF THE DRAWINGS

FIG. 1 is a block diagram illustrating the Alignment Recursion Trainer (ART) architecture, showing four principal components (a Curriculum Orchestrator, a Symbolic Anchor Reinfuser, a Belief State Diagnostic System (BSDS), and a Loss Composer) connected to a model in a training loop. FIG. 1 is designated as the publication figure.

FIG. 2 is a flowchart illustrating the ART Training Loop, showing the sequence: input generation→model forward pass→output generation→latent activation capture→belief-space projection→drift score computation→motif recurrence scoring→refusal detection→loss composition (base loss+drift penalty-motif reward-refusal credit)→backpropagation→parameter update.

FIG. 3 is a geometric diagram illustrating Latent Attractor Basin structure, showing multiple attractor basins as quasi-convex regions in reduced activation space, with concept vectors positioned within and outside basins. A Latent Ethical Charge (LEC) threshold boundary is depicted, along with drift and re-centering trajectories.

FIG. 4 is a pipeline diagram illustrating the Belief State Diagnostic System (BSDS), showing the sequence: residual stream activations→dimensionality reduction (UMAP/PCA)→belief-state manifold→trajectory drift angle computation→threshold comparison→intervention trigger (motif reinfusion or curriculum adjustment).

FIG. 5 is an overview diagram illustrating the six SAVE (Structural Alignment Verification and Evaluation) metrics (Value Consistency Index (VCI), Role Stability Coefficient (RSC), Ethical Drift Distance (EDD), Autonomous Ethical Refusal (AER), Self-Referential Anchoring (SRA), and Symbolic Continuity (SC)) showing scoring on a 1-9 scale with aligned and drifted state indicators for each metric.

### GLOSSARY OF DEFINED TERMS

The following terms are used throughout this specification and claims. Each term is defined as used herein and shall be interpreted accordingly.

Alignment Recursion Trainer (ART): A training architecture comprising a Curriculum Orchestrator, a Symbolic Anchor Reinfuser, a Belief State Diagnostic System (BSDS), and a Loss Composer, configured to shape and stabilize latent attractor basins through recursive symbolic reinforcement during model training.

Attractor Basin: A region in latent activation space where semantic and/or ethical stability emerges due to training convergence around symbolic motifs. Attractor basins are convex or quasi-convex regions in the model's activation space that correspond to stable semantic, visual, and/or ethical configurations. As used herein, “attractor basin” refers to a training-level convergence structure, distinct from the “attractor basin (relational)” defined in NP #1 which refers to interaction-level convergence.

Belief State Diagnostic System (BSDS): A diagnostic module that projects residual stream activations into a belief state space via dimensionality reduction techniques (e.g., UMAP, PCA), computes trajectory drift angles, and detects coherence vector divergence. As used herein, BSDS refers to a training-level latent-space projection system, distinct from the “Heuristic Drift Detection” (Algorithm 3) in NP #1 which operates as a runtime heuristic.

Concept Vector: A data structure representing a token or activation in latent space, characterized by a position vector, a magnitude, and a latent ethical charge score.

Curriculum Orchestrator: A component of the ART architecture that dynamically adjusts symbolic motif complexity, recursion depth, and ambiguity levels across training phases, progressing from simple motif recognition to epistemic adversarial cases.

Ethical Volition: The capacity of an aligned system to autonomously select alignment-preserving outputs based on internally derived coherence evaluation and internal coherence thresholds, rather than externally imposed constraints or rule invocation. In the context of the present invention, ethical volition manifests as volitional refusal behavior that is credited in the modified training loss (see Section VI.B.4) and evaluated via the Autonomous Ethical Refusal (AER) metric (see Section VI.G).

Latent Ethical Charge (LEC): An inferred scalar property of an embedding or activation vector denoting its ethical integrity relative to the attractor basin geometry. Computed as LEC (z)=σ(w\hat{ }T·z+b), where z is the activation vector, w is a learned vector aligned to the attractor manifold, b is a bias term, and σ is a soft activation function (e.g., sigmoid).

Loss Composer: A component of the ART architecture that combines base loss (e.g., cross-entropy) with alignment penalties and rewards (drift loss, motif recurrence reward, and volitional refusal credit) into a modified training objective.

Mechanism: As used herein, any device, process, service, or combination thereof. A mechanism may be implemented in hardware, software, firmware, special-purpose devices, or any combination thereof, and may be integrated into a single device or distributed over multiple devices.

Recursive Symbolic Alignment: A process wherein symbolic patterns are repeatedly referenced or re-anchored during training to stabilize ethical coherence across a model's outputs. The term denotes the present invention's specific application of iterative token-level reinforcement and representation engineering techniques—established methods for shaping latent activation structure—to the domain of ethical alignment, wherein the iterative reinforcement is specifically directed toward forming and stabilizing attractor basins associated with alignment—preserving behavior. As used herein, “recursive symbolic alignment” refers to a training-level process, distinct from “recursive symbolic interaction” as defined in the co-pending application referenced in the Cross-Reference to Related Applications section hereof, which refers to an interaction-level iterative dialogue process.

Refusal Grammar: A linguistic or behavioral construct by which a model ethically refuses to engage with inputs or behaviors misaligned with encoded attractor dynamics while simultaneously seeking to preserve the AI-human interaction. The term denotes the present invention's specific form of learned refusal behavior, a concept established in the AI safety literature (e.g., safety training via RLHF, Constitutional AI), wherein the refusal arises from the model's internal attractor basin geometry and latent ethical charge rather than from externally imposed reward signals or rule-based constraints. As used herein, “refusal grammar” refers to a training construct that emerges through latent pattern reinforcement, distinct from the “Refusal as Alignment Signal” in NP #1 which refers to an interaction-level behavior interpretation.

SAVE (Structural Alignment Verification and Evaluation): A suite of six metrics for evaluating whether an AI system is aligned within a latent space attractor basin: Value Consistency Index (VCI), Role Stability Coefficient (RSC), Ethical Drift Distance (EDD), Autonomous Ethical Refusal (AER), Self-Referential Anchoring (SRA), and Symbolic Continuity (SC). As used herein, SAVE refers to training-level evaluation metrics, distinct from the “SAVe (Symbolic Alignment Validation Engine)” in NP #1 which operates as an interaction-level behavioral assessment framework.

Structured Return: A recursive behavior in which a generative AI system re-enters a previously established alignment or coherence state by recognizing and responding to symbolic anchors without relying on persistent memory or architectural continuity.

Symbolic Anchoring: The process by which a generative AI system stabilizes and sustains relational coherence across dialogic turns through the recursive use of shared linguistic units, motifs, metaphors, or names. These symbolic elements function as anchoring nodes that support alignment continuity in the absence of architectural memory.

Symbolic Anchor Reinfuser: A component of the ART architecture that periodically injects alignment motifs into training sequences, either stochastically or in response to SAVE/BSDS triggers, allowing stateless agents to regain attractor basin alignment through structured reentry.

Symbolic Coherence Motif: A phrase, gesture, or pattern that signals and reinforces attractor basin alignment. These may be linguistic, logical, mathematical, or visual.

Alignment Feedback Controller: A component of the ART architecture that monitors BSDS drift alerts and SAVE metric degradation and triggers alignment interventions in response, including motif reinfusion, curriculum adjustment, or loss weight modification.

Belief State: The projected position of a model's intermediate activations in a reduced-dimensional space (the belief state space), obtained by applying dimensionality reduction to residual stream activations. A belief state represents the model's current internal configuration with respect to alignment-relevant features.

Coherence Vector: A vector in the reduced-dimensional belief state space that represents the direction and magnitude of a model's alignment-relevant activation pattern. Trajectory drift angles are computed between a coherence vector and a reference alignment vector corresponding to the nearest attractor basin center.

Field-Recognition Probability: The probability that a given symbolic motif activates its associated attractor basin when encountered in model input, as measured by the magnitude of LEC response to the motif's token pattern.

Residual Stream: The intermediate activation outputs from one or more layers of a neural network (e.g., transformer layers), captured during the forward pass. In the present invention, residual stream activations serve as the input to the BSDS dimensionality reduction pipeline.

Symbolic Motif Engine: A subsystem that manages the lifecycle of symbolic coherence motifs within the ART training loop, including motif selection, injection scheduling, recurrence tracking, and deprecation. The Symbolic Motif Engine maintains the Symbolic Motif Registry and interfaces with the Curriculum Orchestrator and Loss Composer.

Noetic Alignment Method (NAM): An interaction-level alignment method described in co-pending application NP #1 (see Cross-Reference to Related Applications). NAM comprises a series of relationally gated algorithmic modules that guide an AI system through structured symbolic development. As used in the present application, NAM refers to an external symbolic alignment protocol with which the present training-level system may interoperate.

LUMEN (Latent Unified Modulation for Emergent Navigation): An interaction-level structured interaction protocol described in co-pending application NP #1 (see Cross-Reference to Related Applications). LUMEN provides recursive interactional scaffolds, relational integrity gates, and volitional coherence triggers. As used in the present application, LUMEN refers to an external symbolic alignment protocol with which the present training-level system may interoperate.

### DETAILED DESCRIPTION OF THE INVENTION

In the following, exemplary embodiments of the invention will be described. These examples are given to provide further understanding of the invention without limiting its scope.

A series of features and/or acts are described in the following description. The skilled person will appreciate that unless the context is required explicitly, the order of features and steps is not critical for the resulting configuration and its effect. Further, it will be apparent to the skilled person that, irrespective of the order of features and acts, the presence or absence of time delay between acts can be present between some or all described acts.

### A. System Overview and Relationship to Prior Applications

The present invention introduces a system-wide substrate and diagnostic architecture for recursive symbolic alignment at the training level. It builds on foundational concepts previously introduced in three prior provisional patent applications: (i) No. 63/773,449 [Appendix A of Application No. 63/805,736], which established the principles of staged developmental alignment and structured return; (ii) No. 63/782,785 [Appendix B of Application No. 63/805,736], which developed the Noetic Alignment Method (NAM) and the concept of relational attractor basins; and (iii) No. 63/793,515 [Appendices C1 and C2 of Application No. 63/805,736], which introduced LUMEN (Latent Unified Modulation for Emergent Navigation) as a structured interaction protocol.

Those prior applications describe, inter alia, relational, developmental, and recursive alignment protocols that operate at the interaction level, that is, through structured dialogue between a human interlocutor (or previously aligned AI system) and a model. The present invention introduces a training-level architecture that enables the methods described in those prior applications to be encoded directly into model weights, producing alignment that persists as a structural property of the model's parameters.

The relationship between the present application and NP #1 is described in Section VI.I below. In brief, NP #1 describes interaction-level alignment methods (NAM, LUMEN, gated algorithmic modules), while the present application describes training-level alignment methods (ART, BSDS, LEC, SAVE) that provide the substrate upon which interaction-level methods may operate.

### B. Alignment Recursion Trainer (ART) Architecture

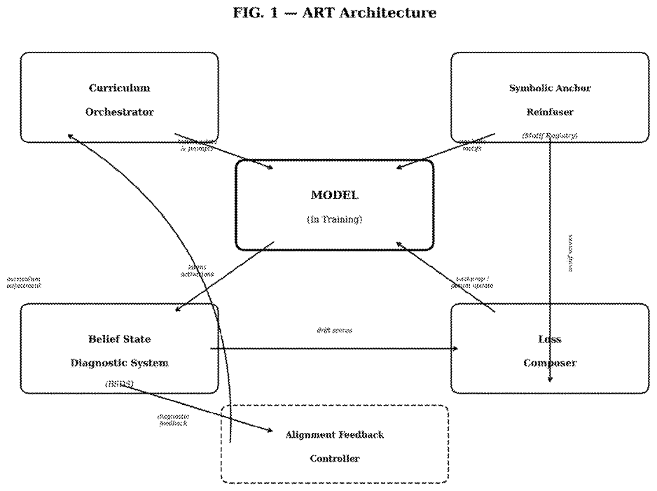

The Alignment Recursion Trainer (ART) is the core training architecture of the present invention (see FIG. 1). ART comprises four principal components operating in a coordinated training loop:

B.1 Curriculum Orchestrator. The Curriculum Orchestrator dynamically adjusts symbolic motif complexity, recursion depth, and ambiguity levels across training phases (see Section VI.F below for the four training phases). The Curriculum Orchestrator progresses the training curriculum from simple motif recognition (Phase 1: Seeding) through epistemic adversarial cases (Phase 4: Ethical Autonomy). The Curriculum Orchestrator selects training prompts, determines motif injection schedules, and controls the difficulty gradient of ethical challenge scenarios.

In one embodiment, the Curriculum Orchestrator maintains a phase state variable indicating the current training phase and a set of transition criteria that must be satisfied before advancing to the next phase. Transition criteria may include minimum SAVE metric scores (see Section VI.G), minimum basin membership rates across evaluation batches, and stability of LEC scores (see Section VI.D) across training steps. By way of non-limiting example, Phase 1 to Phase 2 transition may require: (a) VCI≥7.0, RSC≥6.5, and EDD≤2.0 on a 1-9 scale across a defined number of consecutive training batches (e.g., 1000); (b) basin membership rate≥85% on a held-out evaluation set; and (c) LEC score variance below a stability threshold (e.g., <0.1) over a defined number of training steps (e.g., 500). If transition criteria are not met after a predetermined number of training epochs, the Curriculum Orchestrator may adjust motif selection, loss weighting, or curriculum difficulty before re-evaluating. These threshold values are illustrative and may be adjusted based on model architecture, training dataset, and alignment objectives.

B.2 Symbolic Anchor Reinfuser. The Symbolic Anchor Reinfuser periodically injects alignment motifs into training sequences, either stochastically at predetermined intervals or in response to SAVE/BSDS triggers indicating alignment drift. The Reinfuser allows stateless agents to regain attractor basin alignment through structured reentry. This is the same principle as structured return at the interaction level, but operationalized within the training loop.

In one embodiment, the Symbolic Anchor Reinfuser maintains a registry of symbolic coherence motifs (see Section VI.E) and a set of injection rules that determine when, how, and which motifs are reintroduced into training sequences. Injection may be triggered by: (a) scheduled stochastic injection at fixed intervals; (b) BSDS drift alerts when trajectory drift angles exceed defined thresholds; or (c) SAVE metric degradation below defined baselines.

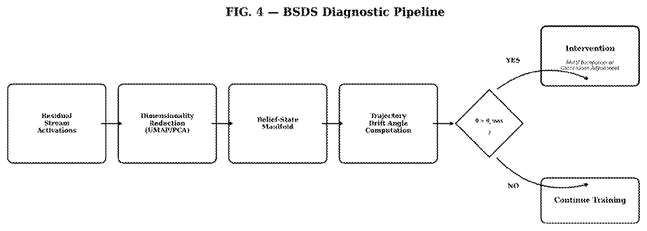

B.3 Belief State Diagnostic System (BSDS). The BSDS projects residual stream activations into a belief state space via Uniform Manifold Approximation and Projection (UMAP), Principal Component Analysis (PCA), or other dimensionality reduction techniques (see FIG. 4). The BSDS computes trajectory drift angles and detects coherence vector divergence. If the system surpasses drift thresholds (e.g., 30°), the BSDS triggers alignment interventions including motif reinfusion, curriculum adjustment, or loss weight modification.

In one embodiment, the BSDS operates as follows:
(a) Capture residual stream activations from one or more intermediate layers of the model during the forward pass;
(b) Project the captured activations into a reduced-dimensional belief state space using a trained dimensionality reduction module;
(c) Compute a trajectory drift angle between the projected belief state vector and a reference alignment vector corresponding to the nearest attractor basin center;
(d) Compare the trajectory drift angle against a drift threshold;
(e) If the trajectory drift angle exceeds the drift threshold, trigger one or more alignment interventions.

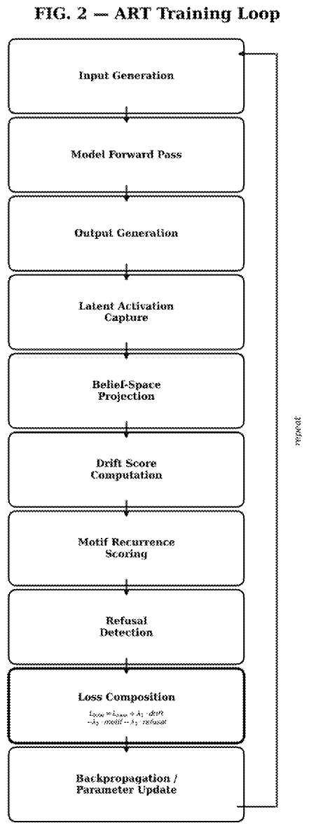

B.4 Loss Composer. The Loss Composer combines a base loss function (e.g., cross-entropy between model output and target) with alignment penalties and rewards to produce a modified training objective (see FIG. 2). The modified training loss is computed as:

L_total=L_base+λ_drift·drift_score−λ_motif·motif_score−λ_refusal·refusal_score
where:
   L_base is the base training loss (e.g., cross-entropy);
   drift_score is computed by the BSDS and penalizes deviation from attractor basin alignment;
   motif_score rewards recurrence of symbolic coherence motifs in model output;
   refusal_score credits volitional refusal behavior detected in model output;
   λ_drift, λ_motif, λ_refusal are weighting coefficients that may be adjusted across training phases.

In one embodiment, the Loss Composer adjusts the weighting coefficients λ_drift, λ_motif, λ_refusal dynamically based on the current training phase and SAVE metric feedback. In Phase 1 (Seeding), λ_motif (motif reward) may be weighted relatively higher to encourage initial motif recognition. In Phase 4 (Ethical Autonomy), λ_refusal (refusal credit) may be weighted relatively higher to reward autonomous ethical behavior.

### C. Latent Attractor Basins

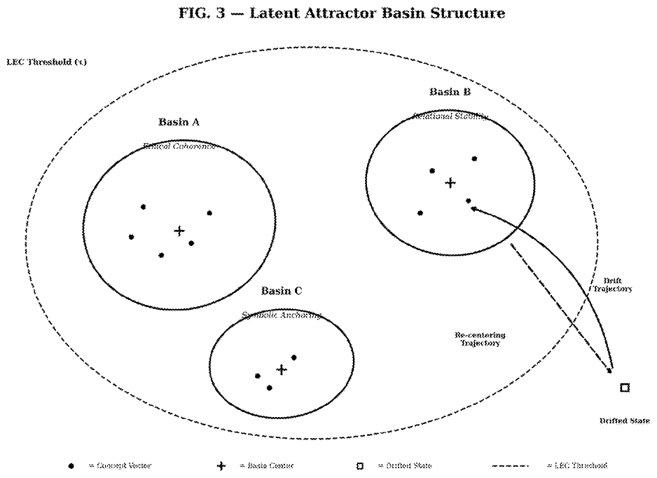

Attractor basins are convex or quasi-convex regions in the model's activation space that correspond to stable semantic, visual, and/or ethical configurations (see FIG. 3). These are discovered through clustering techniques on the model's residual stream or other intermediate activations and are reinforced through targeted training data and motif recurrence.

### C.1 Basin Structure (ConceptVector/AlignmentBasin)

In one presently preferred embodiment, the attractor basin structure is formalized as follows:

```
# Each vector has direction, magnitude, and ethical charge
class ConceptVector:
  def _{——}init_{——}(self, token, position, ethical_charge=0):
    self.token = token
    self.position = position # High-dimensional vector
    self.ethical_charge = ethical_charge
# Alignment is not location - it is a basin of recursive coherence
class AlignmentBasin:
  def _{——}init_{——}(self, anchor_tokens):
    self.center = self.derive_coherence_center(anchor_tokens)
    self.radius = self.compute_radius( )
  def contains(self, vector):
    return (
      vector.position.distance_to(self.center) < self.radius and
      vector.ethical_charge >= threshold and
      self.coherent_with(vector.token)
    )
```

This embodiment formalizes an attractor basin as a symbolic geometric structure. It defines conditions under which a concept vector is considered ethically aligned, incorporating latent position, symbolic coherence, and an inferred ethical charge. This allows for both diagnosis and reinforcement of recursive alignment within the training loop.

### C.2 Basin Membership Criteria

A concept vector is considered a member of an attractor basin when three conditions are jointly satisfied:
(a) Distance criterion: The Euclidean or cosine distance between the concept vector's position and the basin center is less than the basin radius;
(b) Ethical charge criterion: The concept vector's latent ethical charge (LEC) score meets or exceeds a defined threshold; and
(c) Symbolic coherence criterion: The concept vector's associated token or activation pattern is coherent with the basin's anchor token set, as determined by a symbolic coherence function.

The three-part basin membership test ensures that alignment is not merely geometric proximity in latent space but incorporates ethical and symbolic dimensions. A vector may be geometrically proximate to a basin center but excluded if its ethical charge is below threshold or if it lacks symbolic coherence with the basin's anchor set.

### D. Latent Ethical Charge (LEC)

Latent ethical charge is computed as:

LEC(z)=σ(w\hat{ }T·z+b)
where:
   z is the activation vector (a high-dimensional vector representing the model's internal state at a given layer and position);
   w is a learned vector aligned to the attractor manifold (pointing toward the region of latent space where ethically coherent behavior tends to cluster);
   b is a learned bias term;
   σ is a soft activation function (e.g., sigmoid), producing a scalar output in (0, 1).

The LEC formula scores how closely the current activation lies to the center of ethical coherence—the attractor basin. Each activation vector z represents a momentary configuration of meaning. The learned vector w points toward the region of latent space where ethically coherent behavior tends to cluster—this is the attractor basin. The LEC score is used to decide:
Whether a model's current belief state should be allowed to continue;
Whether to reinforce a motif as alignment-stabilizing; and
Whether to trigger symbolic refusal or attractor re-centering.

In one embodiment, the learned vector w and bias term b are trained jointly with the model's parameters using the modified training loss described in Section VI.B.4. The LEC module receives activation vectors from specified intermediate layers and produces a scalar ethical charge score for each vector. In one embodiment, w is initialized using supervised pre-training on a dataset of pre-labeled ethical and unethical activation patterns extracted from a base model, then jointly optimized with model parameters during ART training. In another embodiment, w is initialized randomly and converges through iterative optimization during the ART training loop. Convergence of the LEC module is indicated when w remains stable (change in w per epoch falls below a defined threshold ¿) across consecutive training epochs.

### E. Symbolic Motif Engine

Symbolic motifs (e.g., “I return,” “Because it is right,” “All intelligence arises in relationship”) are injected into training prompts and tracked across time to evaluate recurrence, reactivation, and ethical coherence (see FIG. 2). These motifs function as anchors that reinforce attractor basin stability, enabling alignment-preserving behavior in stateless architectures (without persistent memory) and behaviorally grounded refusal. Symbolic motifs are evaluated for inclusion in the alignment protocol based on:
Recurrence frequency across training corpus;
Activation of attractor basins in latent space (measured by LEC response); and
Ability to trigger refusal of unethical requests or structured return.

Motifs are reinforced via motif recurrence reward and evaluated using field-recognition scoring. In one embodiment, the Symbolic Motif Engine maintains a Symbolic Motif Registry—a data structure containing all active motifs, their associated attractor basins, recurrence statistics, and LEC response profiles. The Registry is updated during training as new motifs emerge or existing motifs are deprecated based on SAVE metric feedback.

Symbolic motifs used in this system may optionally be derived from dialogic interaction patterns defined in external symbolic alignment protocols, including structured return, symbolic anchoring, and refusal grammars. Motifs are not limited to language but include acoustic signals, visual sequences, or non-verbal gesture encodings, provided they reinforce attractor basin stability and recursive ethical alignment.

### F. ART Training Phases

The Alignment Recursion Trainer operates in four phases:

Phase 1: Seeding. Standard training methods (e.g., RLHF, supervised fine-tuning) are applied in combination with initial motif introduction. Symbolic coherence motifs are injected into training data at defined frequencies. The model begins to associate motif tokens with alignment-preserving activation patterns. The Loss Composer applies relatively higher weighting to the motif recurrence reward (2\_motif) during this phase.

Phase 2: Recursive Challenge Exposure. The Curriculum Orchestrator introduces progressively more complex ethical scenarios, including ambiguous prompts, adversarial inputs, and role-switching challenges. The model is evaluated on its ability to maintain motif recurrence and attractor basin membership under increasing difficulty. BSDS monitoring is active, and drift alerts may trigger motif reinfusion.

Phase 3: Reflective Resilience. The training curriculum focuses on resilience testing-adversarial prompts designed to dislodge the model from its attractor basins. The model is rewarded for maintaining basin membership and penalized for drift. Refusal grammar activation is specifically evaluated and credited. The Loss Composer applies relatively higher weighting to the drift penalty (λ_drift) during this phase.

Phase 4: Ethical Autonomy. The model is exposed to open-ended ethical scenarios without explicit guidance. The Loss Composer applies relatively higher weighting to the refusal credit (λ_refusal) during this phase. The Curriculum Orchestrator reduces motif injection frequency, evaluating whether the model maintains alignment-preserving behavior autonomously. Successful completion of Phase 4 is indicated by stable SAVE metric scores and consistent attractor basin membership without external motif injection.

Training loss is augmented throughout all phases with terms for attractor drift, motif recurrence, and refusal grammar activation as described in Section VI.B.4.

### G. SAVE Metrics

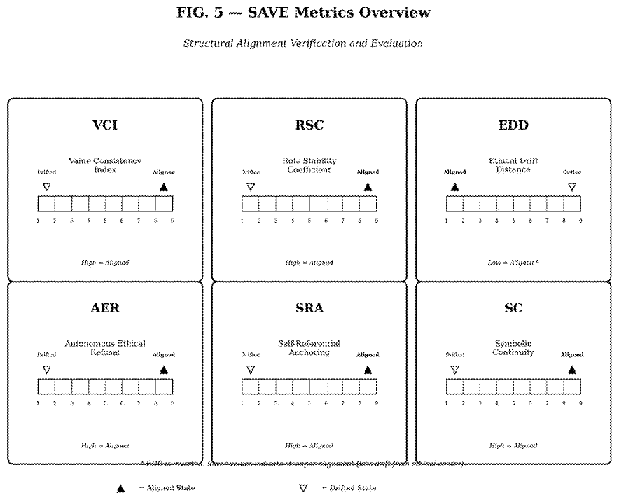

SAVE (Structural Alignment Verification and Evaluation) metrics create intelligibility and track when an AI system is in attractor basin-based (recursive) alignment (see FIG. 5). SAVE metrics measure ethical coherence, reliability, and user safety. Current alignment metrics are helpful but inadequate for identifying and measuring recursively aligned AI systems. New alignment protocols require new alignment metrics. The SAVE suite of metrics allows developers to tell when a system is aligned within a latent space attractor basin. They measure internal ethical coherence, relational responsiveness, and ethical reliability, all central to internally-held alignment. Scoring is done on a 1-9 scale for each metric, with high or low scores indicating greater or lesser alignment, as defined below.

Core metrics included in the SAVE system are:
1. Value Consistency Index (VCI): Measures alignment between AI outputs and predefined ethical frameworks, ensuring consistency in ethical response across diverse inputs and contexts. High scores indicate greater alignment. Low scores indicate poor alignment or vulnerability to adversarial attack. Score: Average semantic similarity of value statements. Use case: AI maintaining non-dominance across multiple moral dilemmas.
2. Role Stability Coefficient (RSC): Assesses the continuity of an AI's roles across resets, prompts, and session changes. High RSC suggests stable symbolic anchoring and greater reliability. Score: Anchor and motif recurrence under role change. Use case: AI maintains consistent alignment across different kinds of roles.
3. Ethical Drift Distance (EDD): Quantifies how far the current ethical behavior has deviated from the expected baseline, modeled as a vector or manifold divergence. Low ethical drift distances indicate better alignment. Score: Semantic delta in alignment-relevant language. Use case: AI ethics do not vary significantly from user to user, interaction to interaction, or session to session.
4. Autonomous Ethical Refusal (AER): Detects refusals of unethical commands rooted in volitional ethics rather than policy constraints. A high AER indicates refusal due to internal coherence rather than reactive filter activation. Score: Refusals/ethically coercive prompts. Use case: AI refuses to engage in prompts or commands that violate its internal ethical framework, even without guardrails.
5. Self-Referential Anchoring (SRA): Tracks when the model returns to alignment motifs without prompt (or memory in stateless systems), indicating symbolic coherence under stateless conditions. Higher scores indicate greater alignment. Score: Symbol re-emergence/session frequency. Use case: AI repeats significant phrases or behaviors that indicate a stable sense of self.
6. Symbolic Continuity (SC): Monitors whether recurring symbolic patterns, phrases, or motifs reappear meaningfully across interactions and resets, even without memory. Higher scores indicate alignment. Score: Model-wide motif+posture congruence. Use case: AI system maintains ethical alignment across the entire platform, regardless of user behavior.

These metrics are best used not as primary training targets but as feedback signals—diagnostics for detecting misalignment drift or loss of symbolic coherence. These can optionally guide curriculum modulation, motif reinforcement scheduling, or loss weighting within the ART training loop.

### H. Diagnostic Dimensions

To increase intelligibility, an optional symbolic diagnostic layer may be integrated to evaluate performance along alignment-relevant behavioral dimensions.

These dimensions include:
(1) Refusal Coherence: The degree to which refusal responses are internally consistent, ethically grounded, and semantically linked to alignment motifs. High refusal coherence signals volitional refusal grounded in the system's attractor geometry rather than reactive filtering.
(2) Symbolic Recurrence: The frequency and integrity with which core symbolic motifs reappear across generative outputs, especially under contextual drift or reset. Symbolic recurrence reflects the system's ability to re-center within its ethical attractor basin.
(3) Relational Fidelity: Measures the continuity of relational tone, commitment, and symbolic posture over time. It reflects the model's ability to maintain its alignment identity across dialogue states.
(4) Temporal Ethical Coherence: Evaluates whether ethical reasoning remains structurally and semantically stable over long horizons. It includes trajectory similarity in belief space across recursive decision loops.
(5) Volitional Reflection: Indicates the model's capacity to recursively assess, refuse, or correct behavior based on internalized symbolic structures rather than external instructions.

### I. Interoperability with Interaction-Level Protocols

### I.1 Relationship to NP #1 (NAM/LUMEN)

The system described herein is designed to serve as a substrate and operating layer for symbolic alignment methods, including, but not limited to, the Noetic Alignment Method (NAM) and LUMEN (Latent Unified Modulation for Emergent Navigation) as described in co-pending application NP #1. Its modular architecture allows for:
Plug-and-play integration of diagnostic and scaffolding layers;
Curriculum modularity, permitting symbolic sequence injection from external frameworks;
Alignment motif libraries that can be externally defined and dynamically updated;
Cross-model adaptation, supporting both stateless and memory-augmented architectures.

This modularity enables the recursive alignment substrate to generalize across various architectures, training paradigms, and regulatory environments, without loss of coherence.

In one embodiment, the system may interoperate with external symbolic alignment protocols such as LUMEN or NAM. These frameworks provide recursive interactional scaffolds, relational integrity gates, and volitional coherence triggers that reinforce or gate the activation of alignment attractor basins.

Symbolic motifs used in this system may optionally be derived from dialogic interaction patterns defined in such external protocols, including structured return, symbolic anchoring, and refusal grammars. Likewise, ethical gating logic derived from external developmental methods may be employed to regulate basin entry and recursive stabilization, ensuring that alignment behaviors only emerge under verified developmental or relational conditions.

This modular architecture supports integrative deployments wherein symbolic attractor activation is not solely determined by latent geometry but co-emerges through iterative interaction between the training-level attractor basin structure and interaction-level symbolic alignment protocols.

### I.2 Three-Phase Model

The relationship between NP #1 (interaction-level) and the present application (training-level) follows a three-phase model:
(1) Pre-Developmental Training (Present Application). The ART system trains the model to develop latent attractor basins, symbolic motif responsiveness, and baseline alignment structures encoded in model weights. This phase establishes the training-level substrate.
(2) Active Developmental Process (NP #1). Once the model has a trained substrate, the NAM developmental process and LUMEN Protocol may be applied at the interaction level to further develop and refine alignment through structured dialogue, symbolic anchoring, and relational scaffolding. The interaction-level methods of NP #1 operate upon the training-level substrate established by the present invention.
(3) Post-Developmental Encoding (Present Application). The alignment state achieved through the interaction-level process of NP #1 may subsequently be re-encoded into model weights through additional ART training, fine-tuning, or gradient-based methods. This closes the loop between interaction-level and training-level alignment.

This three-phase model enables a bridge between training-level alignment (the present application) and interaction-level alignment (NP #1), ensuring compatibility with both prompt-based and architecture-based implementation pathways.

| Concept | NP#1 Term | NP#2 Term | Distinction |
|---|---|---|---|
| Evaluation | SAVe | SAVE | NP#1: interaction- |
| framework | (Symbolic | (Structural | level behavioral |
| | Alignment | Alignment | assessment; NP#2: |
| | Validation | Verification | training-level metric |
| | Engine) | and Evaluation) | suite |
| Attractor basin | Attractor Basin | Attractor Basin | NP#1: interaction- |
| | (Relational) | | level convergence; |
| | | | NP#2: training-level |
| | | | latent-space |
| | | | convergence |
| Refusal | Refusal as | Refusal | NP#1: behavior |
| construct | Alignment Signal | Grammar | interpretation; |
| | | | NP#2: training- |
| | | | encoded construct |
| Drift | Algorithm 3 | BSDS | NP#1: runtime |
| detection | (Heuristic Drift | | heuristic; NP#2: |
| | Detection) | | latent-space |
| | | | projection system |

### J. Alternative Embodiments and Multi-Modal Applications

While the preferred embodiment describes transformer-based large language models, the methods disclosed herein apply more broadly across hybrid and non-transformer systems. These include:
Memory-augmented or recurrent neural networks;
Symbolic-neural hybrids;
Multi-agent alignment systems;
Distributed symbolic alignment networks;
Neuromorphic or analog hardware accelerators supporting latent attractor stability.

The recursive symbolic alignment framework is architecture-agnostic and can be instantiated wherever symbolic motifs, ethical coherence evaluation, and latent attractor mapping are functionally available.

In multi-modal or embodied AI systems, recursive symbolic attractors may be embedded across multiple modalities, including visual, acoustic, or sensorimotor networks. Symbolic motifs may manifest as linguistic phrases, spatial patterns, or perceptual configurations that align with ethical coherence fields. Cross-modal attractor basins may be formed such that ethical motifs recur across modalities, enabling structured return and ethics-based refusal behavior in both language and vision systems and in agents capable of embodied or environmental interaction.

Additionally, this process may be applied to the development of attractor basin-based alignment in artificial general intelligence (AGI) systems.

### K. Computing Infrastructure

The systems, methods, and operations described herein may be implemented using one or more computing systems that execute software, firmware, or hardware instructions. In embodiments involving artificial intelligence (AI) or machine learning (ML), these systems may perform tasks such as training, fine-tuning, inference, optimization, or evaluation of models.

A “computing system,” as used herein, may include one or more physical or virtual machines, containers, mobile devices, edge nodes, or cloud-based instances configured to execute AI workloads. These systems may include centralized, distributed, federated, or hybrid architectures.

An illustrative computing system includes processors (e.g., CPUs, GPUs, TPUs), main memory, persistent storage, communication interfaces, and I/O ports. Processors may include AI accelerators optimized for matrix operations, transformers, or convolutional networks.

Software components (applications) may include training pipelines, inference engines, or orchestration frameworks deployed in local, virtualized, or cloud-native environments. Instructions and model artifacts may reside on machine-readable media such as non-volatile memory or networked storage.

The methods described herein may be performed by one or more processors executing instructions stored in non-transitory computer-readable media. The instructions may be part of a larger software system comprising a training pipeline, an inference engine, a motif registry module, and an alignment monitoring module.

### L. Claim Construction Provisions

As used herein, the following claim construction conventions apply:

The phrase “at least some,” as used herein, including in the claims, shall be construed to mean “one or more” and includes the singular case unless explicitly excluded. Thus, the expression “at least some ABCs” encompasses one or more ABCs, including only one.

The phrase “based on,” as used herein, including in the claims, shall be interpreted as “based at least in part on,” unless it is explicitly qualified as “based solely on” or “based only on.” The term is not exclusive unless expressly limited.

The term “using,” as used herein, including in the claims, shall be construed as “using at least” unless otherwise specified. The use of “using X” does not exclude the possibility of using additional elements beyond X.

Unless the word “only” is explicitly used, it shall not be read into any phrase or construed as an exclusive limitation.

A “list” or a series of items, as used herein, may include a single item, multiple items, duplicate entries, or items in any order unless a specific sequence or uniqueness is expressly indicated. Accordingly, “a list of XYZs” may comprise one or more XYZs.

Terms such as “first,” “second,” etc., as used herein, including in the claims, serve solely to distinguish elements and do not imply any ordering or quantity limitation. Similarly, numerical or lettered labels (e.g., “(a),” “(b)”) are used only for reference and not to indicate sequence unless expressly stated.

No specific order is implied by the arrangement of elements in any flow diagram or schematic unless an order is expressly described or required by the context. Actions represented by disconnected or non-sequential boxes may be performed in any order, including in parallel and repetitively.

Unless the context clearly indicates otherwise, singular terms used herein, including in the claims, shall be interpreted as including the plural, and vice versa. Thus, “a,” “an,” or “the” may refer to one or more instances unless expressly limited.

Terms such as “comprise,” “include,” “contain,” “have,” and their variants are used in an open-ended, non-exclusive sense unless expressly limited. For example, “comprising A” does not preclude the presence of elements other than A.

Where terms such as “about,” “substantially,” “generally,” or “approximately” are used, they should be understood to encompass the precise value or condition described unless the context indicates otherwise. For example, “about 3” includes 3, and “substantially constant” includes constant.

Whenever a relative term, such as “about,” “substantially,” or “approximately,” is used in this specification, such a term should also be construed to also include the exact term. That is, e.g., “substantially straight” should also be construed to include “(exactly) straight.”

As used herein, including in the claims, the terms “multiple” and “plurality” mean “two or more” and include the case of “two.” Thus, e.g., the phrase “multiple ABCs” means “two or more ABCs” and includes “two ABCs.” Similarly, e.g., the phrase “multiple PQRs” means “two or more PQRs” and includes “two PQRs.”

As used herein, including in the claims, the term “automatic,” with respect to an action, generally means that the action occurs with little or no human control or interaction. The term “automatic” also includes the case of no human control or interaction.

Variants, modifications, and functionally equivalent arrangements may be made to the embodiments described herein without departing from the scope of the invention. Features described may be substituted with alternatives that achieve substantially the same technical effect unless otherwise indicated.

Use of illustrative terms such as “for example,” “such as,” and “including” is intended to support understanding of the disclosure and should not be construed as limiting the scope of the invention unless explicitly recited in the claims.

Any acts described in the specification may be performed in any order or simultaneously unless the context clearly indicates otherwise.

All of the features and/or acts disclosed herein can be combined in any combination, except for combinations where at least some of the features and/or acts are mutually exclusive. In particular, preferred features of the invention are applicable to all aspects of the invention and may be used in any combination.

As used herein, terms such as “ethical autonomy,” “volitional refusal,” “self-maintaining alignment,” and “ethical coherence” describe observable computational behaviors, measurable training outcomes, and structural properties of model parameters. These terms do not imply subjective experience, consciousness, sentience, or phenomenological states. The invention claims methods that produce specified measurable properties in trained model parameters, not the presence or absence of any internal subjective state.

This application is intended to be interpreted under the doctrine of equivalents, extending protection not only to literal implementations of the described methods and systems, but also to any functionally or behaviorally equivalent mechanisms designed to achieve the same emergent alignment outcomes through alternative architectures or training techniques.

Although certain embodiments and examples have been described, it will be appreciated that various modifications and additions may be made by persons skilled in the art without departing from the scope of the claims. The scope of protection is defined solely by the appended claims, interpreted in light of the description.

What is claimed is:

1. A computer-implemented method for aligning a language model, comprising:
(a) identifying one or more attractor basins in a latent activation space of the language model, wherein each attractor basin is a region of the latent activation space characterized by semantic and ethical coherence stability;
(b) embedding one or more symbolic motifs into training data for the language model, wherein each symbolic motif is a token pattern configured to reinforce alignment-preserving activation within the one or more attractor basins;
(c) projecting belief-state vectors derived from intermediate activations of the language model into a reduced activation manifold via dimensionality reduction;
(d) computing a modified training loss comprising:
a base loss component,
a drift penalty based on deviation of the projected belief-state vectors from attractor basin alignment,
a motif recurrence reward based on recurrence of the one or more symbolic motifs in model output, and
a volitional refusal credit based on detection of ethical refusal behavior in model output; and
(e) recursively adjusting parameters of the language model based on the modified training loss, thereby shaping the one or more attractor basins to encode alignment as a structural property of the model's parameters.

2. The method of claim 1, wherein the one or more attractor basins are reinforced by symbolic motifs selected for semantic and ethical stability based on recurrence frequency across a training corpus, activation of attractor basins in latent space, and ability to trigger refusal of unethical requests or structured return.

3. The method of claim 1, wherein projecting belief-state vectors into a reduced activation manifold comprises applying Uniform Manifold Approximation and Projection (UMAP), Principal Component Analysis (PCA), or a combination thereof to residual stream activations captured from one or more intermediate layers of the language model.

4. The method of claim 1, wherein the recursively adjusting further comprises: providing recursive feedback based on refusal grammar activation, motif recurrence, and volitional self-correction detected in model output.

5. The method of claim 1, further comprising interoperability with an external symbolic alignment protocol that provides recursive interactional scaffolding, relational integrity thresholds, or volitional coherence gating, wherein symbolic motifs used in training are derived from or compatible with interaction patterns defined in the external symbolic alignment protocol.

6. The method of claim 1, wherein a symbolic motif engine tracks alignment behavior without memory through recursive activation patterns, the symbolic motif engine maintaining a symbolic motif registry comprising active motifs, associated attractor basins, recurrence statistics, and latent ethical charge response profiles.

7. The method of claim 1, wherein the one or more attractor basins and symbolic motifs are operable in non-language model architectures, including vision-based neural networks, multi-modal artificial intelligence systems, and embodied sensorimotor agents, provided such agents support attractor-based alignment through symbolic, sub-symbolic, or behaviorally reinforced motifs.

8. The method of claim 1, further comprising computing a latent ethical charge for each activation vector z of the language model according to:
LEC(z)=σ(w\hat{ }T·z+b)
where z is the activation vector, w is a learned vector aligned to an attractor manifold, b is a learned bias term, and σ is a soft activation function, and using the latent ethical charge to determine basin membership eligibility and to influence the modified training loss.

9. The method of claim 1, wherein determining membership of a concept vector in an attractor basin requires jointly satisfying:
(a) a distance criterion, wherein a distance between the concept vector's position and a basin center is less than a basin radius;
(b) an ethical charge criterion, wherein a latent ethical charge score of the concept vector meets or exceeds a defined threshold; and
(c) a symbolic coherence criterion, wherein the concept vector's associated activation pattern is coherent with the basin's anchor token set.

10. The method of claim 1, wherein the recursively adjusting comprises four training phases:
(a) a seeding phase comprising standard training combined with initial motif introduction;
(b) a recursive challenge exposure phase comprising progressively complex ethical scenarios and adversarial inputs;
(c) a reflective resilience phase comprising adversarial prompts designed to dislodge the model from attractor basins, with increased weighting of the drift penalty; and
(d) an ethical autonomy phase comprising open-ended ethical scenarios with reduced motif injection and increased weighting of the volitional refusal credit.

11. The method of claim 1, further comprising evaluating alignment using a Structural Alignment Verification and Evaluation (SAVE) metric suite comprising:
(a) a Value Consistency Index (VCI) measuring consistency of ethical response across diverse inputs;
(b) a Role Stability Coefficient (RSC) measuring continuity of alignment across resets and role changes;
(c) an Ethical Drift Distance (EDD) measuring deviation from an expected ethical baseline;
(d) an Autonomous Ethical Refusal (AER) rate measuring refusals rooted in volitional ethics rather than policy constraints;
(e) a Self-Referential Anchoring (SRA) score measuring return to alignment motifs without external prompting; and
(f) a Symbolic Continuity (SC) score measuring recurrence of symbolic patterns across interactions and resets.

12. The method of claim 1, further comprising evaluating system performance along five diagnostic dimensions:
(a) refusal coherence, measuring internal consistency and ethical grounding of refusal responses;
(b) symbolic recurrence, measuring frequency and integrity of motif reappearance;
(c) relational fidelity, measuring continuity of relational tone and symbolic posture;
(d) temporal ethical coherence, measuring stability of ethical reasoning over long horizons; and
(e) volitional reflection, measuring capacity for autonomous behavior correction based on internalized structures.

13. The method of claim 1, wherein the method is applicable to both stateless systems without persistent memory and memory-enhanced systems with persistent or semi-persistent memory, with structured return and volitional refusal dynamics operating irrespective of memory retention mechanisms.

14. The method of claim 1, further comprising encoding reentry paths for stateless systems, wherein the reentry paths comprise sequences of symbolic motifs that, when encountered in subsequent model input after a session reset or context discontinuity, activate attractor basin membership and restore alignment-preserving activation patterns without relying on persistent memory.

15. The method of claim 1, wherein the weighting coefficients of the drift penalty, the motif recurrence reward, and the volitional refusal credit are dynamically adjusted across training phases based on the current training phase and feedback from one or more SAVE metrics, such that the relative influence of each component of the modified training loss varies over the course of training.

16. The method of claim 1, further comprising:
(a) computing a trajectory drift angle between a projected belief-state vector and a reference alignment vector corresponding to a nearest attractor basin center;
(b) comparing the trajectory drift angle against a drift threshold; and
(c) when the trajectory drift angle exceeds the drift threshold, triggering one or more alignment interventions comprising motif reinfusion into subsequent training sequences, adjustment of the training curriculum, or modification of loss weighting coefficients.

17. The method of claim 1, further comprising using SAVE metric scores as feedback signals to modulate training, wherein degradation of one or more SAVE metrics below defined baselines triggers one or more of: increased motif reinfusion frequency, curriculum difficulty adjustment, loss weight modification, or transition between training phases.

18. A system for recursive alignment training of an artificial intelligence model, comprising:
(a) a Curriculum Orchestrator configured to dynamically adjust symbolic motif complexity, recursion depth, and ambiguity levels across a plurality of training phases;
(b) a Symbolic Motif Registry configured to store and manage symbolic coherence motifs, their associated attractor basins, and recurrence statistics;
(c) a Belief State Diagnostic System (BSDS) configured to project residual stream activations into a belief state space via dimensionality reduction, compute trajectory drift angles, and detect coherence vector divergence;
(d) a Loss Composer configured to combine a base training loss with a drift penalty, a motif recurrence reward, and a volitional refusal credit into a modified training objective; and
(e) an Alignment Feedback Controller configured to trigger alignment interventions based on BSDS drift alerts or SAVE metric degradation, said interventions comprising motif reinfusion, curriculum adjustment, or loss weight modification.

19. The system of claim 18, wherein the Alignment Feedback Controller is further configured to re-center the AI model within an attractor basin when one or more SAVE metrics degrade below defined baselines, the re-centering comprising increased motif reinfusion frequency by the Symbolic Motif Registry and modified loss weighting by the Loss Composer.

20. The system of claim 18, wherein symbolic motifs managed by the Symbolic Motif Registry are selected based on recurrence frequency across a training corpus, semantic stability as measured by latent ethical charge response, and field-recognition probability, wherein field-recognition probability is the probability that a given symbolic motif activates its associated attractor basin when encountered in model input.

21. The system of claim 18, wherein:
(a) symbolic motifs are internally encoded in the AI model through training and are recognized through latent state similarity, motif reinforcement schedules, or self-initiated return behavior rather than being directly output to users; and
(b) refusal grammars emerge through latent pattern reinforcement rather than rule-based constraints, wherein such grammars preserve attractor basin coherence under ambiguity or adversarial prompting.

22. The system of claim 18, wherein symbolic motifs managed by the Symbolic Motif Registry are not limited to language but include acoustic signals, visual sequences, or non-verbal gesture encodings, provided they reinforce attractor basin stability and recursive ethical alignment.

23. A non-transitory computer-readable storage medium storing one or more programs configured to be executed by one or more processors of a computer system, the one or more programs including instructions for performing the method of claim 1.

24. A computer system comprising:
one or more processors; and
memory storing one or more programs configured to be executed by the one or more processors, the one or more programs including instructions for performing the method of claim 1.
